(19) United States
(12) Patent Application Publication
(10) Pub. No.: US 2026/0359596 A1
(43) Pub. Date: Nov. 12, 2026

(54) CONTEXTUAL INSTRUCTION FLOW FOR EFFICIENT SUB-TASK PROCESS

(71) Applicant: QUALCOMM Incorporated, San Diego, CA (US)

(72) Inventors: Juntae LEE, Seoul (KR); Jihwan BANG, Seoul (KR); Seunghan YANG, Incheon (KR); Kyuhong SHIM, Seoul (KR); Minsoo KIM, Seoul (KR); Simyung CHANG, Suwon (KR)

(21) Appl. No.: 19/201,846

(22) Filed: May 7, 2025

(51) Int. Cl. G06N 3/04; G06N 3/084

(52) U.S. Cl. CPC G06N 3/04; G06N 3/084

(57) ABSTRACT

Systems and techniques are described herein for generating content. In an example, a device may have at least one memory and least one processor coupled to the at least one memory and configured to: obtain first data for processing a first task using a machine learning model, wherein the first task comprises a sub-task, generate second data for processing the sub-task, process the first data and the second data using the machine learning model to perform the sub-task and generate a sub-task output, wherein at least part of the first data, the second data, and the sub-task output are stored in a cache based on performance of the sub-task, remove at least part of the second data from the cache; and process, using the machine learning model, the first data and the sub-task output from the cache to perform the first task and to generate a task output.

### FIELD

The disclosure relates generally to systems and techniques for improved machine learning systems, including improved processing of tasks and related sub-tasks via machine learning systems.

### BACKGROUND

Machine learning systems (or models), such as neural networks (e.g., deep neural networks) are widely used for numerous applications, such as generative operations (e.g., to generate images, language/text outputs, etc.), object detection, object classification, object tracking, big data analysis, among others. For example, convolutional neural networks (CNNs) are able to extract high-level features, such as facial shapes, from an input image, and use these high-level features to output a probability that, for example, an input image includes a particular object.

A generative machine learning system can process data to generate desired output content from an input (e.g., a natural language input, input image(s) or video(s), a noise input such as for diffusion models, etc.). For instance, a language-based generative machine learning model (e.g., a large language model (LLM)) can generate natural language responses from natural language inputs and can incorporate various forms of data, such as audio, images and text. In some cases, a generative machine learning system can include an encoder that processes input features to generate output features (also referred to as embeddings or encodings) and can use the output features to generate relevant output content in a given form (e.g., in a natural language form, as generated images and/or video, as audio, explanation of the content, etc.).

A generative machine learning system can perform a wide range of tasks, such as answering questions, providing explanations, generating creative content, assisting with coding, and offering recommendations. Various tools may be used in conjunction with the generative ML system to allow interaction with external systems, such as browsing the Internet, generating images, executing code, etc. Generative ML systems are designed to assist users in solving problems, learning new information, and enhancing productivity.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In some aspects, an apparatus for generating content is provided. The apparatus includes at least one memory and at least one processor coupled to the at least one memory and configured to: obtain first data for processing a first task using a machine learning model, wherein the first task includes a sub-task; generate second data for processing the sub-task; process the first data and the second data using the machine learning model to perform the sub-task and generate a sub-task output, wherein at least part of the first data, the second data, and the sub-task output are stored in a cache based on performance of the sub-task; remove at least part of the second data from the cache; and process, using the machine learning model, the first data and the sub-task output from the cache to perform the first task and to generate a task output.

In some aspects, a method for generating content is provided. The method includes: obtaining first data for processing a first task using a machine learning model, wherein the first task includes a sub-task; generating second data for processing the sub-task; processing the first data and the second data using the machine learning model to perform the sub-task and generate a sub-task output, wherein at least part of the first data, the second data, and the sub-task output are stored in a cache based on performance of the sub-task; removing at least part of the second data from the cache; and processing, using the machine learning model, the first data and the sub-task output from the cache to perform the first task and to generate a task output.

In some aspects, a non-transitory computer-readable medium is provided having stored thereon instructions that, when executed by one or more processors, cause the one or more processors to: obtain first data for processing a first task using a machine learning model, wherein the first task includes a sub-task; generate second data for processing the sub-task; process the first data and the second data using the machine learning model to perform the sub-task and generate a sub-task output, wherein at least part of the first data, the second data, and the sub-task output are stored in a cache based on performance of the sub-task; remove at least part of the second data from the cache; and process, using the machine learning model, the first data and the sub-task output from the cache to perform the first task and to generate a task output.

In some aspects, an apparatus for generating content is provided. The apparatus includes: means for obtaining first data for processing a first task using a machine learning model, wherein the first task includes a sub-task; means for generating second data for processing the sub-task; means for processing the first data and the second data using the machine learning model to perform the sub-task and generate a sub-task output, wherein at least part of the first data, the second data, and the sub-task output are stored in a cache based on performance of the sub-task; means for removing at least part of the second data from the cache; and means for processing, using the machine learning model, the first data and the sub-task output from the cache to perform the first task and to generate a task output.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example implementation of a system-on-a-chip (SOC), in accordance with some examples;

FIG. 2 is a block diagram illustrating an example of a deep learning neural network, according to some aspects of the present disclosure;

FIG. 3 is a block diagram illustrating an example of a convolutional neural network (CNN), according to various aspects of the present disclosure;

FIG. 4 is a block diagram illustrating an example of a deep convolutional network, in accordance with aspects of the present disclosure;

FIG. 5 is a block diagram illustrating a task flow involved in a conventional multi-turn conversation with a single large language model, in accordance with aspects of the present disclosure;

FIG. 6 is a block diagram illustrating a contextual instruction flow for an efficient sub-task process, in accordance with aspects of the present disclosure;

FIG. 7 is a block diagram illustrating a task flow for efficient sub-task processing using a single large language model, in accordance with aspects of the present disclosure;

FIG. 8 is a flow diagram illustrating an example of a process for efficient sub-task processing in machine learning models, in accordance with aspects of the disclosure;

FIG. 9 is a block diagram of an example transformer in accordance with aspects of the present disclosure; and

FIG. 10 illustrates an example computing device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Machine learning models can be trained to perform various functions and/or provide various types of outputs. For instance, some generative machine learning models can provide a conversational interface that uses natural language prompts as inputs, such as text or voice. In some examples, a user can provide an input prompt in natural language to the generative machine learning model, and the generative machine learning model can provide a response in natural language form. The input prompt and the output response can optionally be combined with one or more other types of information or data, such as images or files.

Large Language Models (LLMs) are increasingly used to handle diverse tasks due to their powerful capabilities. For instance, LLMs may be used to power an autonomous agent that answers questions from a user in the context of a multi-turn conversation. To support such a conversation, multiple sub-tasks may be needed. Examples of relevant sub-tasks in this context include user query rewriting, conversation summarization, sentiment analysis, and handling Application Programming Interface (API) calls.

In some applications, using a single LLM is advantageous for various tasks. However, as described herein, using a single LLM for different sub-tasks may cause overhead due to re-generating data, state, and/or instructions. In the context of managing a conversation, such operations may include prefilling a conversation history or generating task-specific instructions. Such operations are complex and resource intensive, especially in the context of machine learning models (including LLMs), which require significant compute, memory, power, and/or time resources.

Systems, apparatuses, processes (also referred to as methods), and computer-readable media (collectively referred to as “systems and techniques”) are described herein for efficiently executing tasks via machine learning models (also referred to as machine learning systems). The systems and techniques address the above-described challenges, such as by enabling more efficient execution of sub-tasks on a single model (e.g., executed on a computing device).

According to some aspects, the systems and techniques described herein can minimize re-computation of intermediate data and/or instructions required for sub-tasks, which can lower an amount of computing resources needed for performing the sub-tasks. For instance, in the context of a multi-turn conversation, a primary task state may be encapsulated and positioned immediately following a prior conversation. Such a structure allows for efficient isolation and rapid restoration of the primary task state.

The systems and techniques can be used with Retrieval Augmented Generation (RAG). For instance, a RAG system may not have sufficient knowledge to answer a user question. In such cases, the system may query an external database. In so doing, a RAG system may augment or clarify a user's query before providing the query to an external system.

In a RAG system, a user input query may be provided to a knowledge repository. The repository may rephrase the user query and query an external database with the rephrased query to obtain a response. The system may provide the response as appearing from an agent. The query and response may be part of a multi-turn conversation. For instance, the system may be provided the instruction “Instruction: Answer the user question only based on the given knowledge.” For example, a user may state “I watched the movie Inception.” The system may be provided the context “Context: [Knowledge for inception].” In response, the agent outputs “Sounds good.” The user may then ask “Who is the director of the movie?” Because the user question is unclear, the system rewrites the response for more accurate retrieval as “What is the director of the movie ‘Inception’?”

Various aspects of the disclosure are discussed in detail below. While specific implementations are discussed, such implementations are described for illustration purposes only. A person skilled in the relevant art will recognize that other components and configurations may be used without parting from the spirit and scope of the disclosure.

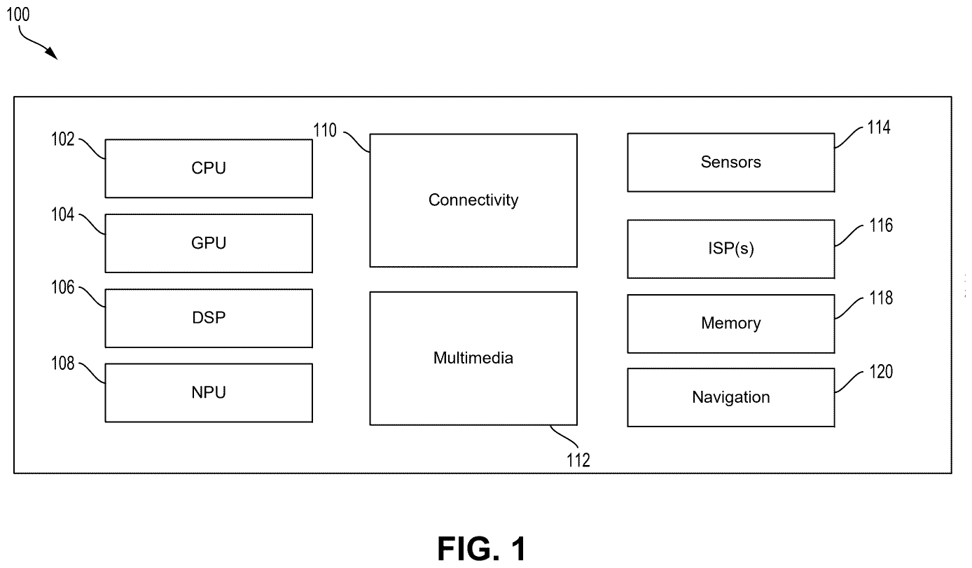

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. SOC 100 and/or components thereof may be configured to perform segmentation mask extrapolation. For example, the CPU 102, DSP 106, and/or GPU 104 may be configured to perform object detection using a visual language model via latent feature adaptation with synthetic data.

In some cases, the SOC 100 may process data using neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

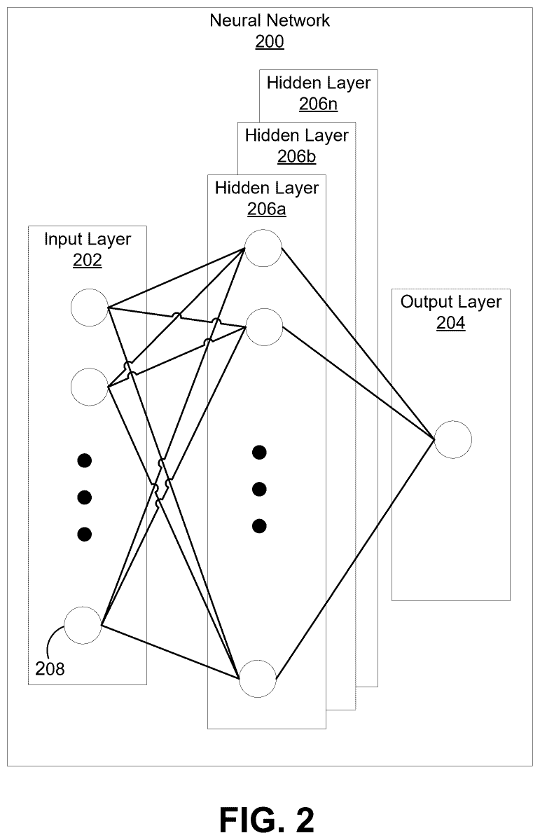

FIG. 2 is an illustrative example of a neural network 200 (e.g., a deep-learning neural network) that can be used to implement machine-learning-based image generation, feature segmentation, implicit-neural-representation generation, rendering, classification, object detection, image recognition (e.g., face recognition, object recognition, scene recognition, etc.), feature extraction, authentication, gaze detection, gaze prediction, and/or automation. The neural network 200 may be run, for example, on one or more processors, such as CPU 102 of FIG. 1, GPU 104 of FIG. 1, DSP 106 of FIG. 1, NPU 108 of FIG. 1, etc.

An input layer 202 includes input data. Neural network 200 includes multiple hidden layers hidden layers 206a, 206b, through 206n. The hidden layers 206a, 206b, through hidden layer 206n include “n” number of hidden layers, where “n” is an integer greater than or equal to one. The number of hidden layers can be made to include as many layers as needed for the given application. Neural network 200 further includes an output layer 204 that provides an output resulting from the processing performed by the hidden layers 206a, 206b, through 206n.

Neural network 200 may be, or may include, a multi-layer neural network of interconnected nodes. Each node can represent a piece of information. Information associated with the nodes is shared among the different layers and each layer retains information as information is processed. In some cases, neural network 200 can include a feed-forward network, in which case there are no feedback connections where outputs of the network are fed back into itself. In some cases, neural network 200 can include a recurrent neural network, which can have loops that allow information to be carried across nodes while reading in input.

Information can be exchanged between nodes through node-to-node interconnections between the various layers. Nodes of input layer 202 can activate a set of nodes in the first hidden layer 206a. For example, as shown, each of the input nodes of input layer 202 is connected to each of the nodes of the first hidden layer 206a. The nodes of first hidden layer 206a can transform the information of each input node by applying activation functions to the input node information. The information derived from the transformation can then be passed to and can activate the nodes of the next hidden layer 206b, which can perform their own designated functions. Example functions include convolutional, up-sampling, data transformation, and/or any other suitable functions. The output of the hidden layer 206b can then activate nodes of the next hidden layer, and so on. The output of the last hidden layer 206n can activate one or more nodes of the output layer 204, at which an output is provided. In some cases, while nodes (e.g., node 208) in neural network 200 are shown as having multiple output lines, a node has a single output and all lines shown as being output from a node represent the same output value.

In some cases, each node or interconnection between nodes can have a weight that is a set of parameters derived from the training of neural network 200. Once neural network 200 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 200 to be adaptive to inputs and able to learn as more and more data is processed.

Neural network 200 may be pre-trained to process the features from the data in the input layer 202 using the different hidden layers 206a, 206b, through 206n to provide the output through the output layer 204. In an example in which neural network 200 is used to identify features in images, neural network 200 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 200 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 200 is trained well enough so that the weights of the layers are accurately tuned.

For the example of identifying objects in images, the forward pass can include passing a training image through neural network 200. The weights are initially randomized before neural network 200 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 200, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 200 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as

$${E}_{total} = \sum \frac{1}{2} {( target - output )}^{2} .$$

The loss can be set to be equal to the value of Etotal.

The loss (or error) will be high for the first training images since the actual values will be much different than the predicted output. The goal of training is to minimize the amount of loss so that the predicted output is the same as the training label. Neural network 200 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wi denotes the initial weight, and f denotes a learning rate. The learning rate can be set to any suitable value, with a high learning rate including larger weight updates and a lower value indicating smaller weight updates.

Neural network 200 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 200 can include any other deep network other than a CNN, such as an autoencoder, a deep belief nets (DBNs), a Recurrent Neural Networks (RNNs), among others.

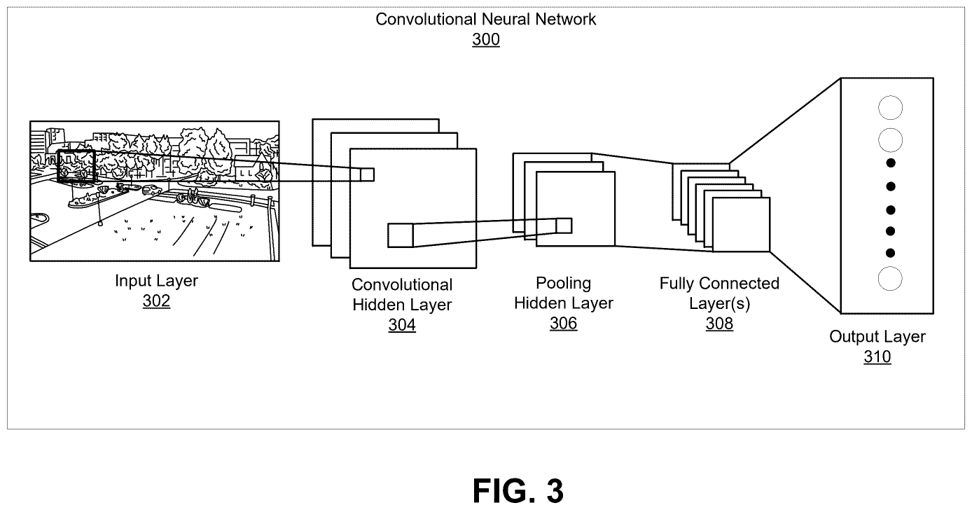

FIG. 3 is an illustrative example of a convolutional neural network (CNN) 300. The input layer 302 of the CNN 300 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 304, an optional non-linear activation layer, a pooling hidden layer 306, and fully connected layer 308 (which fully connected layer 308 can be hidden) to get an output at the output layer 310. While only one of each hidden layer is shown in FIG. 3, one of ordinary skill will appreciate that multiple convolutional hidden layers, non-linear layers, pooling hidden layers, and/or fully connected layers can be included in the CNN 300. As previously described, the output can indicate a single class of an object or can include a probability of classes that best describe the object in the image.

The first layer of the CNN 300 can be the convolutional hidden layer 304. The convolutional hidden layer 304 can analyze image data of the input layer 302. Each node of the convolutional hidden layer 304 is connected to a region of nodes (pixels) of the input image called a receptive field. The convolutional hidden layer 304 can be considered as one or more filters (each filter corresponding to a different activation or feature map), with each convolutional iteration of a filter being a node or neuron of the convolutional hidden layer 304. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 304. Each connection between a node and a receptive field for that node learns a weight and, in some cases, an overall bias such that each node learns to analyze its particular local receptive field in the input image. Each node of the convolutional hidden layer 304 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 304 is due to each node of the convolutional layer being applied to its corresponding receptive field. For example, a filter of the convolutional hidden layer 304 can begin in the top-left corner of the input image array and can convolve around the input image. As noted above, each convolutional iteration of the filter can be considered a node or neuron of the convolutional hidden layer 304. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 304. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 304.

The mapping from the input layer to the convolutional hidden layer 304 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 304 can include several activation maps in order to identify multiple features in an image. The example shown in FIG. 3 includes three activation maps. Using three activation maps, the convolutional hidden layer 304 can detect three different kinds of features, with each feature being detectable across the entire image.

In some examples, a non-linear hidden layer can be applied after the convolutional hidden layer 304. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 300 without affecting the receptive fields of the convolutional hidden layer 304.

The pooling hidden layer 306 can be applied after the convolutional hidden layer 304 (and after the non-linear hidden layer when used). The pooling hidden layer 306 is used to simplify the information in the output from the convolutional hidden layer 304. For example, the pooling hidden layer 306 can take each activation map output from the convolutional hidden layer 304 and generates a condensed activation map (or feature map) using a pooling function. Max-pooling is one example of a function performed by a pooling hidden layer. Other forms of pooling functions be used by the pooling hidden layer 306, such as average pooling, L2-norm pooling, or other suitable pooling functions. A pooling function (e.g., a max-pooling filter, an L2-norm filter, or other suitable pooling filter) is applied to each activation map included in the convolutional hidden layer 304. In the example shown in FIG. 3, three pooling filters are used for the three activation maps in the convolutional hidden layer 304.

In some examples, max-pooling can be used by applying a max-pooling filter (e.g., having a size of 2×2) with a stride (e.g., equal to a dimension of the filter, such as a stride of 2) to an activation map output from the convolutional hidden layer 304. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 304 having a dimension of 24×24 nodes, the output from the pooling hidden layer 306 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. The positional information can be discarded without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 300.

The final layer of connections in the network is a fully-connected layer that connects every node from the pooling hidden layer 306 to every one of the output nodes in the output layer 310. Using the example above, the input layer includes 28×28 nodes encoding the pixel intensities of the input image, the convolutional hidden layer 304 includes 3×24×24 hidden feature nodes based on application of a 5×5 local receptive field (for the filters) to three activation maps, and the pooling hidden layer 306 includes a layer of 3×12×12 hidden feature nodes based on application of max-pooling filter to 2×2 regions across each of the three feature maps. Extending the example, the output layer 310 can include ten output nodes. In such an example, every node of the 3×12×12 pooling hidden layer 306 is connected to every node of the output layer 310.

The fully connected layer 308 can obtain the output of the previous pooling hidden layer 306 (which should represent the activation maps of high-level features) and determines the features that most correlate to a particular class. For example, the fully connected layer 308 can determine the high-level features that most strongly correlate to a particular class and can include weights (nodes) for the high-level features. A product can be computed between the weights of the fully connected layer 308 and the pooling hidden layer 306 to obtain probabilities for the different classes. For example, if the CNN 300 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 310 can include an M-dimensional vector (in the prior example, M=10). M indicates the number of classes that the CNN 300 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

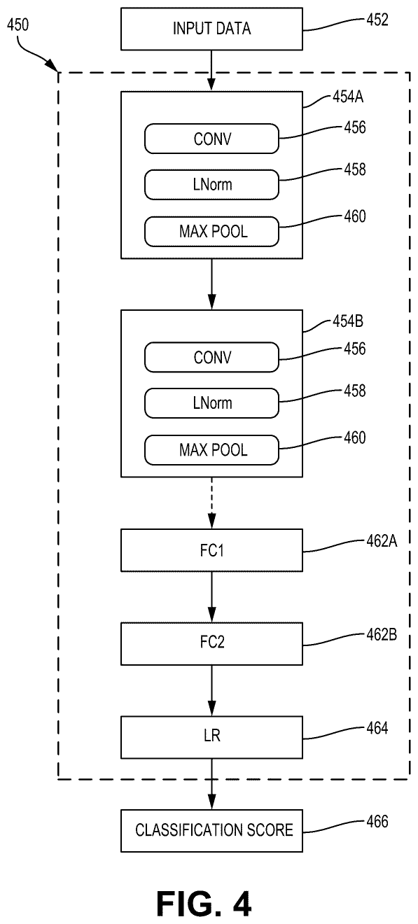

FIG. 4 is a block diagram illustrating an example of a deep convolutional network 450. The deep convolutional network 450 may include multiple different types of layers based on connectivity and weight sharing. As shown in FIG. 4, the deep convolutional network 450 includes the convolution blocks 454A, 454B. Each of the convolution blocks 454A, 454B may be configured with a convolution layer (CONV) 456, a normalization layer (LNorm) 458, and a max pooling layer (MAX POOL) 460. Of note, the layers illustrated with respect to convolution blocks 454A and 454B are examples of layers that may be included in a convolution layer and are not intended to be limiting and other types of layers may be included in any order.

The convolution layers 456 may include one or more convolutional filters, which may be applied to the input data 452 to generate a feature map. Although only two convolution blocks 454A, 454B are shown, the present disclosure is not so limiting, and instead, any number of convolution blocks (e.g., convolution blocks 454A, 454B) may be included in the deep convolutional network 450 according to design preference. The normalization layer 458 may normalize the output of the convolution filters. For example, the normalization layer 458 may provide whitening or lateral inhibition. The max pooling layer 460 may provide down sampling aggregation over space for local invariance and dimensionality reduction.

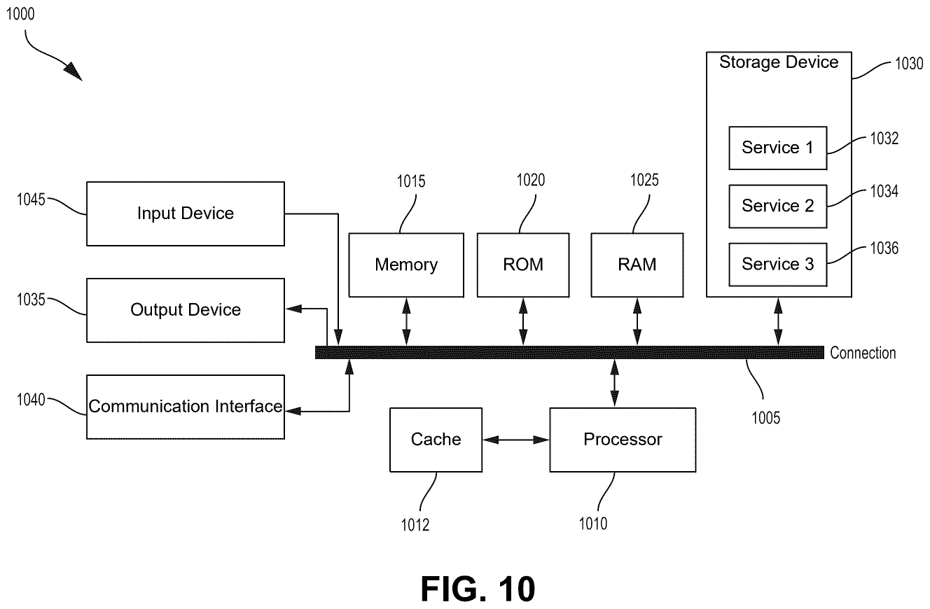

The parallel filter banks, for example, of a deep convolutional network may be loaded on a processor such as a CPU or GPU, or any other type of processor 1010 discussed with respect to the computing device architecture 1000 of FIG. 10 to achieve high performance and low power consumption. In alternative aspects, the parallel filter banks may be loaded on a DSP or an ISP of the computing device architecture 1000 of FIG. 10. In addition, the deep convolutional network 450 may access other processing blocks that may be present on the computing device architecture 1000 of FIG. 10, such as sensor processor and navigation module, dedicated, respectively, to sensors and navigation.

The deep convolutional network 450 may also include one or more fully connected layers, such as layer 462A (labeled “FC1”) and layer 462B (labeled “FC2”). The deep convolutional network 450 may further include a logistic regression (LR) layer 464. Between each layer 456, 458, 460, 462A, 462B, 464 of the deep convolutional network 450 are weights (not shown) that are to be updated. The output of each of the layers (e.g., 456, 458, 460, 462A, 462B, 464) may serve as an input of a succeeding one of the layers (e.g., 456, 458, 460, 462A, 462B, 464) in the deep convolutional network 450 to learn hierarchical feature representations from input data 452 (e.g., images, audio, video, sensor data and/or other input data) supplied at the first of the convolution blocks 454A. The output of the deep convolutional network 450 is a classification score 466 for the input data 452. The classification score 466 may be a set of probabilities, where each probability is the probability of the input data including a feature from a set of features.

In some cases, one or more convolutional networks, such as a DCN, may be incorporated into more complex ML networks. As an example, as indicated above, the deep convolutional network 450 may output probabilities that an input data, such as an image, includes certain features. The deep convolutional network 450 may then be modified to extract (e.g., output) certain features. Additionally, DCNs may be added to extract other features as well. The set of DCNs may function as feature extractors to identify features in an image. In some cases, feature extractors may be used as a backbone for additionally ML network components to perform further operations, such as image segmentation.

In some cases, cross-attention blocks may be used for a variety of applications where complex, non-linear relationships may be learned, such as for language-based tasks. For example, cross-attention blocks may be used in large language models. A cross-attention block may be used in a ML model that can learn context about features to try to detect relationships between sequences of in data to focus on relevant information of a sequence of data while processing another sequence of data. Cross-attention blocks may be inserted into other ML models, such as deep convolutional network 450 of FIG. 4, CNN 300 of FIG. 3, neural network 200 of FIG. 2, etc.

In some cases, one or more convolutional networks, such as a DCN, may be incorporated into more complex ML networks. As an example, as indicated above, the deep convolutional network 450 may output probabilities that an input data, such as an image, includes certain features. The deep convolutional network 450 may then be modified to extract (e.g., output) certain features. Additionally, DCNs may be added to extract other features as well. The set of DCNs may function as feature extractors to identify features in an image. In some cases, feature extractors may be used as a backbone for additional ML network components to perform further operations, such as localization, image segmentation, object detection, etc.

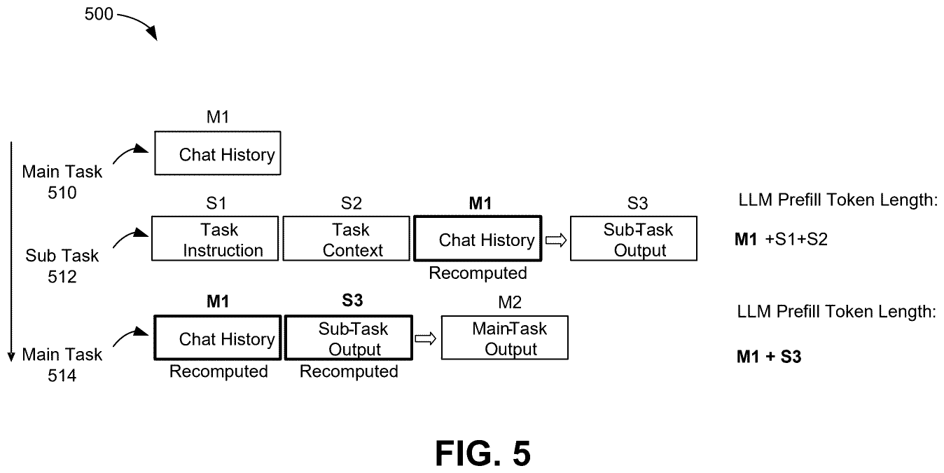

FIG. 5 is a block diagram illustrating a task flow 500 involved in a conventional multi-turn conversation with a single large language model, in accordance with aspects of the present disclosure. Task flow 500 represents an approach to implementing multi-turn conversation using a machine learning model such as an LLM.

Task flow 500 includes first main task flow 510, sub-task flow 512, and second main task flow 514. A main task is executed within first main task flow 510 and second main task flow 514. One or more sub-tasks may be implemented in sub-task flow 512. As illustrated in FIG. 5, a main task begins to execute with first main task flow 510, creating a parallel sub-task flow 512. An output of the parallel sub-task flow 512 is then used to complete the second main task in second main task flow 514.

In some aspects, task flow 500 may be used to implement a RAG system. For instance, in a RAG system, the main task may include processing a user query, and one or more sub-tasks may include generating a re-phrased query. The results of the sub-task are used in completion of the main task.

Main task flow 510 involves accessing chat history M1. For example, chat history M1 may represent a chat history between a user and an assistant (e.g., an autonomous agent). The chat history M1 may increase in length as the conversation grows, turn by turn, and includes each user query and agent response. In some cases, the chat history M1 may include instructions and/or context information, further increasing its size.

For example, in a multi-turn interaction task m, an LLM M generates an answer a(t) for the given user query q(t) at each turn t. In some examples, the LLM can be a small-scaled model such as Llama 3.1 8B. In some aspects, the main question and answer flow can be represented by:

$${a}^{( t )} = m ( M , {C}_{main}^{( t )} , {q}^{( t )} ) ,$$

where

$${C}_{main}^{( t )}$$

denotes the conversational context of M at turn t, including the main task instruction Iₘₐᵢₙ and all previous turns:

$${C}_{main}^{( t )} = \{ \begin{matrix}\{ {I}_{main} \} & if t = 1 \\ \{ {I}_{main} , \{ ( {q}^{( {t}^{′} )} , {a}^{( {t}^{′} )} ) \} \begin{matrix}t - 1 \\ {t}^{′} = 1\end{matrix} \} & otherwise\end{matrix}$$

In some cases, to make a proper answer a(t), the LLM can optionally execute an auxiliary sub-task which supports the main answer but is not directly exposed to the user. In some case, the sub-tasks can be designed to support M, and are represented as a set {s₁, . . . , sₙ}, where sₙ denotes the nth sub-task. Each sub-task may produce an intermediate output

$${o}_{{s}_{n}}^{( t )} :$$

$${o}_{{s}_{n}}^{( t )} = {s}_{n} ( M , {C}_{{s}_{n}}^{( t )} , {q}^{( t )} ) ,$$

where a sub-task-specific instruction Iₛ_{ₙ} is used in place of Iₘₐᵢₙ in

$${C}_{{s}_{n}}^{( t )} .$$

Depending on the type of sₙ,

$${C}_{{s}_{n}}^{( t )}$$

may not need the previous conversation history, in which case

$${C}_{{s}_{n}}^{( t )} = {I}_{{s}_{n}} .$$

Before executing any sub-task sₙ, a classification sub-task μ may need to be performed to determine which sub-task is necessary for the current turn. This classification task is also treated as sub-tasks and precedes actual sub-task executions.

In some cases, in a single-LLM setting, when switching from the sub-tasks to the main task, the conversational context can be re-prefilled even though much of the context is redundant across tasks and turns. Such repeated context reloading may impose significant computational overhead, which can be addressed using the efficient sub-task execution systems and techniques described herein.

Returning to FIG. 5, sub-task flow 512 includes a task instruction S1, a task context S2, the chat history M1, and in turn generates a sub-task output S3. S1 is processed before S2. In the context of a RAG system, the sub-task output S3 may represent the clarified user query generated by the sub-task(s). The sub-task can use the chat history M1 to generate a sub-task output S3, resulting in a prefill token length (e.g., an LLM prefill token length) of M1+S1+S2.

The approach illustrated in FIG. 5 may have limitations, such as requiring increased computational overhead and/or memory bandwidth use. For instance, one or more item(s) may be recomputed, as indicated in FIG. 5. In particular, chat history M1 may need to be recomputed, leading to increased overhead. Additionally, storing the recomputed chat history in memory (e.g., a cache) may be expensive, such as due to the size of the chat history M1, which can be very large due to a multi-turn RAG system. Such a limitation can arise due to configuration requirements of the model, specifically that the chat history M1 should be placed before the sub-task output S3, and that the task instructions S1 and task context S2 must be cleared.

Main task flow 514 continues processing the chat history M1 and the sub-task output S3, generating the main task output M2. Here, the LLM prefill token length is M1+S3.

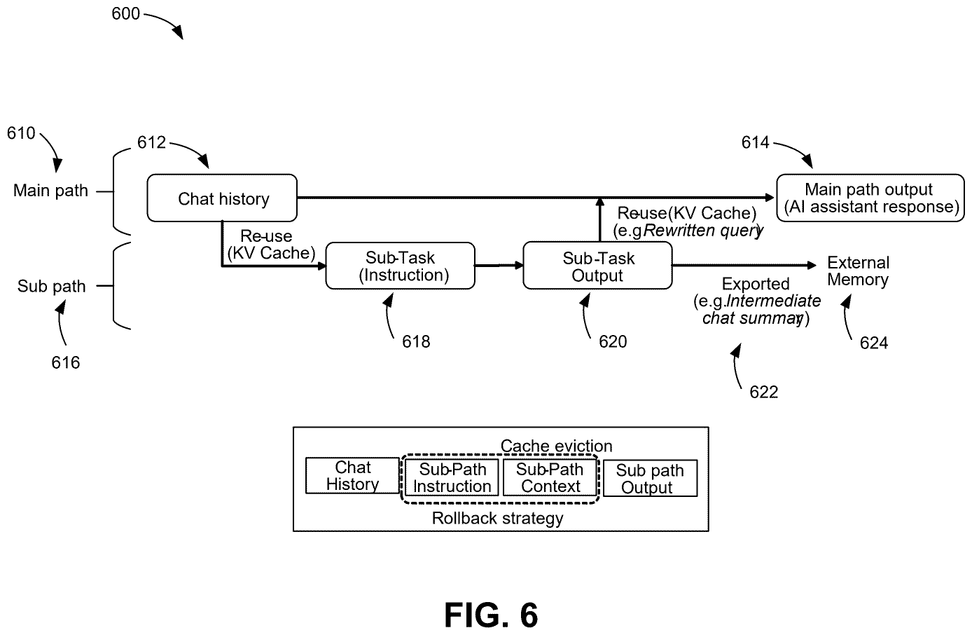

FIG. 6 is a block diagram illustrating a contextual instruction flow 600 for an efficient sub-task process, in accordance with aspects of the present disclosure. While flow 600 is discussed with respect to a chat-based main task and sub-tasks, disclosed techniques are applicable to other tasks performed by machine learning systems.

Flow 600 includes two parallel flows, including main task flow 610 and sub-task flow 616. Main task flow 610 generates main flow output 614. Sub-task flow 616 processes various sub-tasks or operations that are subsequently used by main flow 610 to generate main flow output 614. As illustrated in FIG. 6, main flow output 614 is an autonomous agent response. Other examples are possible.

In the example depicted, main flow 610 provides chat history 612 (or associated keys (K) and/or values (V)) to sub-task flow 616. Sub-task flow 616 performs various operations including processing the chat history 612 and sub-task instruction 618. Sub-task instruction 618 may include one or more keys and/or values that represent an original sub-task instruction. The operations are processed via a machine learning model such as an LLM. The model generates sub-task flow output 620. In turn, the main flow 610 integrates sub-task output 620 to form main flow output 614. Additionally, the sub-task output 620 may result in exported data 622. Exported data 622 may be an intermediate chat summary. The exported data 622 may be stored in an external memory 624.

Data and/or instructions associated with flow 600 may be cached. For instance, sub-task instruction 618 and/or sub-flow output 620, and/or keys or values derived therefrom, may be stored in the cache. Similarly, sub-task output 620 may include one or more keys and/or values.

Disclosed systems improve cache management, resulting in increased efficiency. For instance, rather than erasing and re-filling data (e.g., keys and/or values) representing chat history 612, which is needed to generate the main flow output 614, the system may perform selective eviction (e.g., removal) of items such as sub-task instruction 618 and/or associated task context from the cache. Selective eviction of the items allows reuse of information (e.g., keys and values) representing chat history 612 for continuation of the main task without reloading.

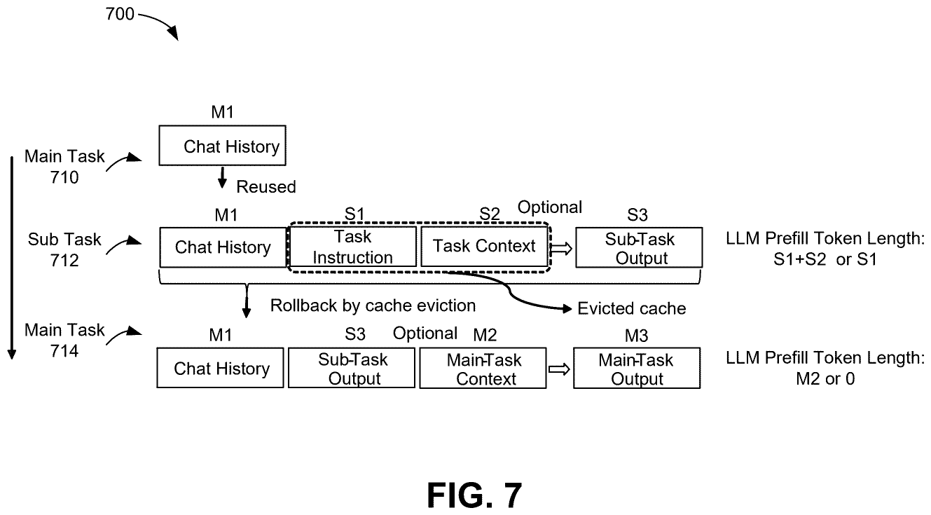

In some cases, the instructions for the model to perform the main task remain part of the chat history 612, removing the need for the instructions to be re-filled. In other cases, the system may refill instructions for the model to perform the main task as needed. Such an approach is discussed further with respect to FIG. 7.

FIG. 7 is a block diagram illustrating a task flow 700 for efficient sub-task processing using a single large language model, in accordance with aspects of the present disclosure. Task flow 700 includes first main task flow 710, sub-task flow 712, and second main task flow 714. Task flow 700 can represent an improved approach to implementing multi-turn conversation using a machine learning model such as an LLM.

In the example depicted, a main task begins to execute with first main task flow 710, creating a parallel sub-task flow 712, the output of which is then used to complete the second main task in second main task flow 714.

Each task may have an associated context and/or associated instructions. In machine learning, context refers to the surrounding information and conditions that influence how a model interprets and makes decisions, while instructions are the explicit commands or rules a model follows to perform a task. The context may encapsulate a state of the primary task, such that the primary task may be continued after execution of the sub-task(s).

In some cases, a cache is used in conjunction with the machine learning model. The cache is configurable to store the keys and values of one or more parameters such as instructions or data that are used in the system. While a cache is described herein as an illustrative example, other types of memory can be used to store keys and values. As discussed below, certain data and/or instructions may be evicted (e.g., removed) from the cache. Such an approach makes space for other information and also may allow improved access to other remaining data and/or instructions in the cache.

According to various aspects, to enable an efficient sub-task execution, the systems and techniques described herein can use sub-task execution and rollback. For example, once a user query qₜ is issued, a checkpoint can be created at that moment—preserving the key-value (KV) cache of the entire main path up to qₜ. For instance, when t=1:

$${K}_{m a i n}^{( I )} = KVCache ( M , {C}_{m a i n}^{( I )} , {q}^{( 1 )} ) .$$

Based on such a cached state, an appropriate sub-task path can be started. Instead of reprocessing the full conversation context, only the sub-task instruction Iₛ_{ₙ} is prefilled on top of the preserved KV cache:

$${O}_{{s}_{n}}^{( 1 )} = {s}_{n} ( M , {I}_{{s}_{n}} ; {K}_{m a i n}^{( 1 )} )$$

The sub-task sₙ can then be executed efficiently. Although the main instruction Iₘₐᵢₙ is implicitly retained via the KV cache, the sub-task reliably adheres to Iₛ_{ₙ}, without interference from Iₘₐᵢₙ After completing the sub-task, the KV cache related to the sub-task instruction (e.g., Iₛ_{ₙ}) or complex reasoning process can be evicted. In some cases, if necessary, the cache associated with the sub-task's final output

$${O}_{{s}_{n}}^{( 1 )}$$

can be retained, such as based on the following:

$${K}_{rollback}^{( 1 )} = {K}_{m a i n} ⊕ {K}_{{s}_{n}}^{( 1 , o )} ,$$

where ⊗ denotes a concatenation operation.

The cache can then be rolled back to the main path by restoring the previously checkpointed KV cache and the model to continue the main task without re-prefilling the full conversational history as shown:

$${a}^{( 1 )} = m ( M ; {K}_{rollback}^{( 1 )} ) ) .$$

In some cases, when t>1, all of the conversational context

$${C}_{m a i n}^{( t )}$$

can be involved in

$${K}_{rollback}^{( t )} .$$

Such a structured mechanism may be referred to contextual instruction flow, where the shared conversational context is reused and only task-specific instructions are attached or evicted to enable efficient task switching. Thes contextual instruction flow allows for substantially reducing the overall computational cost, switching the main and sub task during multi-turn conversation with a single LLM.

Sub-task classification can also be formulated as a sub-task, where the objective of which includes determining whether each auxiliary sub-task should be executed. Small-scale language models may struggle to comprehend the definitions of multiple sub-tasks simultaneously, often failing to make accurate selections under a multi-choice setup.

For example, priorities can first be assigned to the available sub-tasks using a larger LLM on an offline basis. Then, at runtime, the on-device model can perform binary classification for each sub-task in descending order of priority, only varying the class-specific instruction in the contextual instruction.

$${C}_{{s}_{n}}^{( t )} = {μ}_{n} ( M , {I}_{{μ}_{n}} ; {K}_{m a i n}^{( t )} )$$

If a sub-task with higher priority is classified as necessary, the hierarchical process can be terminated early, and the selected sub-task can be executed. The classification decisions can also be made using the same single LLM instance. As a result, executing multiple binary classifications can lead to a significant increase in prefilling cost. However, only the task-specific classification instructions need to be prefetched, which minimizes redundant computation and ensures efficient task routing.

Referring again to FIG. 7, main task flow 710 involves accessing chat history M1. For example, chat history M1 may represent a chat history between a user and an assistant or autonomous agent. In some cases, chat history M1 may include instructions for the main task. The instructions for the main task are used in both main task flow 710 and main task flow 714.

As described herein, the chat history increases in length as the conversation grows, turn by turn, and includes each user query and agent response. In some cases, the chat history M1 includes instructions to process the user question and/or a state of the primary task. As explained, the chat history M1 may include a state of the primary task. By using the techniques disclosed within, chat history M1 is positioned immediately after prior conversations. Such a structure allows for efficient isolation and rapid restoration of the primary task state.

Sub-task flow 712 includes processing a task instruction S1, optional task context S2, the chat history M1, and in turn generates a sub-task output S3. S1 is processed before S2. Additional data may include instructions to process the chat history, task instructions, and/or task context to guide the sub-task flow 712 to obtain a re-phrased question. The sub-task instruction should be carefully designed to only refer to the chat history avoiding performing the main-flow instructions. In the context of a RAG system, the sub-task output S3 represents the clarified user query. Such an approach results in a LLM prefill token length of M1+S1+S2.

Once processing of sub-task flow 712 is complete, task instruction S1 and optional task context S2 (if present) are evicted from the cache and effectively rolled back, leaving only chat history M1 in the cache. Such a solution allows efficient reuse of the cache between main and sub-task flows.

Once sub-task flow execution is complete, main flow execution may resume. Continuing the example, main task flow 714 continues processing the chat history M1 and the sub-task output S3, generating the main task output M2. Here, extra operations are performed because the LLM prefill token length is M1+S3.

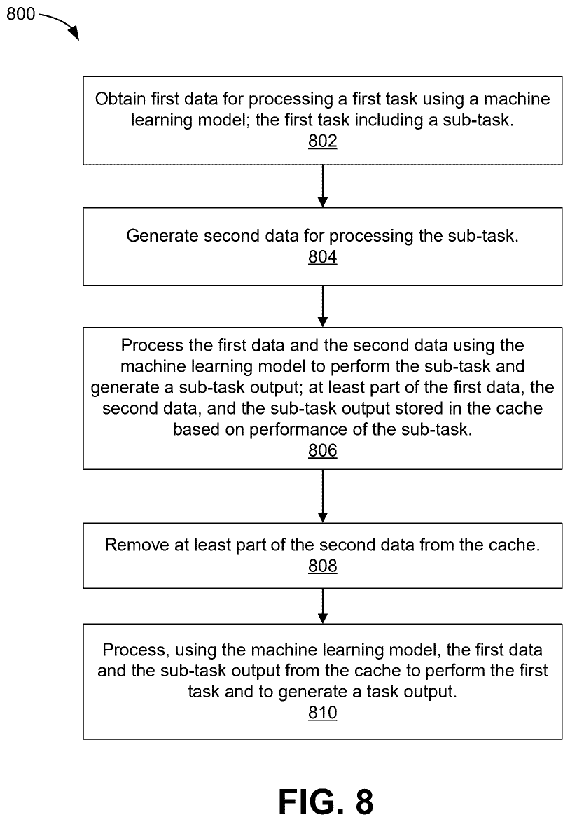

FIG. 8 is a flow diagram illustrating an example of a process 800 for efficient sub-task processing in machine learning models, in accordance with aspects of the disclosure. The process 800 may be performed by a computing device (or apparatus) or a component (e.g., a chipset, codec, etc.) of the computing device. The operations of the process 800 may be implemented as software components that are executed and run on one or more processors (such as CPU 102, GPU 104, DSP 106, NPU 108 of FIG. 1, processor 1010 of FIG. 10′, etc.).

At block 802, the computing device (or component thereof) may obtain first data for processing a first task using a machine learning model; the first task including a sub-task.

In an aspect, the second data includes one or more of a context or an instruction for the sub-task. The context can include information that affects how the machine learning model performs the sub-task. An instruction can include commands provided to the machine learning model for performing the sub-task. In an aspect, the second data includes keys and values. The computing device may be configured to generate the keys and values using the machine learning model. In an aspect, the first data comprises keys and values derived from messages exchanged between an external device and an autonomous agent. The messages may include text associated with a question, and wherein the sub-task represents a rephrased version of the question.

In an aspect, processing the first data and the sub-task output involves processing a main task context. The main task context can include information that affects how the machine learning model performs the first task.

At block 804, the computing device (or component thereof) may generate second data for processing the sub-task.

At block 806, the computing device (or component thereof) may process the first data and the second data using the machine learning model to perform the sub-task and generate a sub-task output, wherein at least part of the first data, the second data, and the sub-task output are stored in a cache based on performance of the sub-task. In an aspect, the machine learning model is a large language model.

At block 808, the computing device (or component thereof) may remove at least part of the second data from the cache.

At block 810, the computing device (or component thereof) may process, using the machine learning model, the first data and the sub-task output from the cache to perform the first task and to generate a task output.

In an aspect, the computing device may output the task output to a database, obtain, from the database, a response to the task output; and provide the response to a user device.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, sand the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 800 and/or other processes described herein may include a processor, microprocessor, micro-computer, or other component of a device that is configured to carry out the steps of the process 800 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 800 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 800 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 800 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

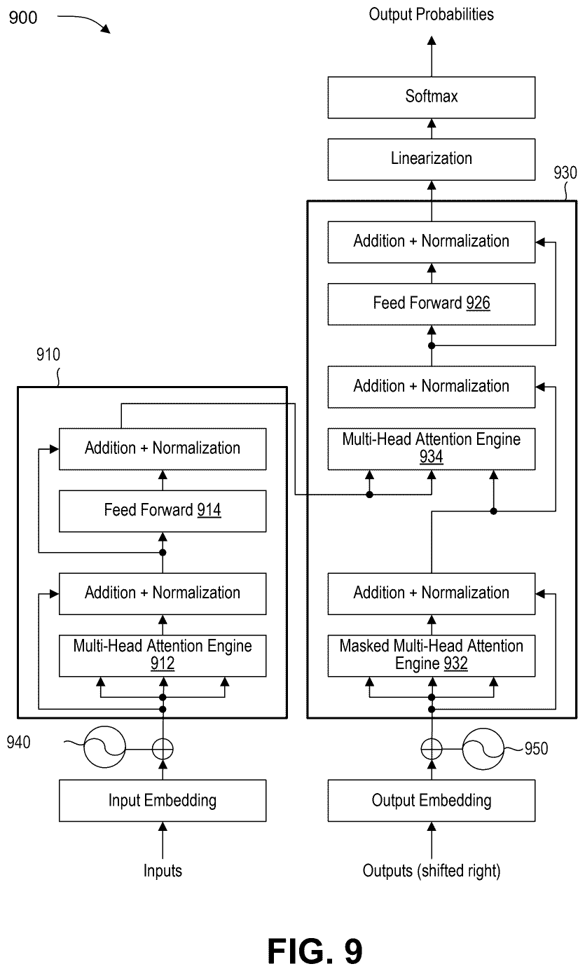

FIG. 9 is a block diagram of an example transformer in accordance with some aspects of the disclosure. In a convolutional neural network (CNN) model, the number of operations required to relate signals from two arbitrary input or output positions grows in the distance between positions, which makes learning dependencies at different distant positions challenging for a CNN model. The transformer 900 reduces the operations of learning dependencies by using an encoder 910 and a decoder 930 that implements an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In some examples of a transformer, the encoder 910 is composed of a stack of six identical layers and each layer has two sub-layers. The first sub-layer is a multi-head self-attention engine 912, and the second sub-layer is a fully connected feed-forward network 914. A residual connection (not shown) connects around each of the sub-layers followed by normalization.

In this example of a transformer 900, the decoder 930 is also composed of a stack of six identical layers. The decoder also includes a masked multi-head self-attention engine 932, a multi-head attention engine 934 over the output of encoder 910, and a fully connected feed-forward network 926. Each layer includes a residual connection (not shown) around the layer, which is followed by layer normalization. The masked multi-head self-attention engine 932 is masked to prevent positions from attending to subsequent positions and ensures that the predictions at position i can depend only on the known outputs at positions less than i (e.g., auto-regression).

In the transformer 900, the queries, keys, and values are linearly projected by a multi-head attention engine into learned linear projects, and then attention is performed in parallel on each of the learned linear projects, which are concatenated and then projected into final values.

The transformer also includes a positional encoder 940 to encode positions because the model does not contain recurrence and convolution and relative or absolute position of the tokens is needed. For example, the positional encodings are added to the input embeddings at the bottom layer of the encoder 910 and the decoder 930. The positional encodings are summed with the embeddings because the positional encodings and embeddings have the same dimensions. A corresponding position decoder 950 is configured to decode the positions of the embeddings for the decoder 930.

In some aspects, the transformer 900 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 900 can process input sequences of variable length, making it well-suited for natural language processing tasks where input lengths can vary greatly. Additionally, the self-attention mechanism allows the transformer 900 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 10 illustrates an example computing device architecture 1000 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 1000 are shown in electrical communication with each other using connection 1005, such as a bus. The example computing device architecture 1000 includes a processing unit (CPU or processor) 1010 and computing device connection 1005 that couples various computing device components including computing device memory 1015, such as read only memory (ROM) 1020 and random access memory (RAM) 1025, to processor 1010.

Computing device architecture 1000 can include a cache of high-speed memory connected directly with, in close proximity to, or integrated as part of processor 1010. Computing device architecture 1000 can copy data from memory 1015 and/or the storage device 1030 to cache 1012 for quick access by processor 1010. In this way, the cache can provide a performance boost that avoids processor 1010 delays while waiting for data. These and other modules can control or be configured to control processor 1010 to perform various actions. Other computing device memory 1015 may be available for use as well. Memory 1015 can include multiple different types of memory with different performance characteristics. Processor 1010 can include any general purpose processor and a hardware or software service, such as service 1 1032, service 2 1034, and service 3 1036 stored in storage device 1030, configured to control processor 1010 as well as a special-purpose processor where software instructions are incorporated into the processor design. Processor 1010 may be a self-contained system, containing multiple cores or processors, a bus, memory controller, cache, etc. A multi-core processor may be symmetric or asymmetric.

To enable user interaction with the computing device architecture 1000, input device 1045 can represent any number of input mechanisms, such as a microphone for speech, a touch-sensitive screen for gesture or graphical input, keyboard, mouse, motion input, speech and so forth. Output device 1035 can also be one or more of a number of output mechanisms known to those of skill in the art, such as a display, projector, television, speaker device, etc. In some instances, multimodal computing devices can enable a user to provide multiple types of input to communicate with computing device architecture 1000. Communication interface 1040 can generally govern and manage the user input and computing device output. There is no restriction on operating on any particular hardware arrangement and therefore the basic features here may easily be substituted for improved hardware or firmware arrangements as they are developed.

Storage device 1030 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1025, read only memory (ROM) 1020, and hybrids thereof. Storage device 1030 can include services 1032, 1034, 1036 for controlling processor 1010. Other hardware or software modules are contemplated. Storage device 1030 can be connected to the computing device connection 1005. In one aspect, a hardware module that performs a particular function can include the software component stored in a computer-readable medium in connection with the necessary hardware components, such as processor 1010, connection 1005, output device 1035, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors or other suitable electronic circuits) to perform the operation, or any combination thereof.

The phrase “coupled to” refers to any component that is physically connected to another component either directly or indirectly and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for generating content, comprising: at least one memory; and at least one processor coupled to the at least one memory and configured to: obtain first data for processing a first task using a machine learning model, wherein the first task comprises a sub-task; generate second data for processing the sub-task; process the first data and the second data using the machine learning model to perform the sub-task and generate a sub-task output, wherein at least part of the first data, the second data, and the sub-task output are stored in a cache based on performance of the sub-task; remove at least part of the second data from the cache; and process, using the machine learning model, the first data and the sub-task output from the cache to perform the first task and to generate a task output.

Aspect 2. The apparatus of Aspect 1, wherein the second data comprises one or more of a context or an instruction for the sub-task, wherein the context comprises information that affects how the machine learning model performs the sub-task, and wherein the instruction comprises commands provided to the machine learning model for performing the sub-task.

Aspect 3. The apparatus of any of Aspects 1-2, wherein the second data comprises keys and values, and wherein the at least one processor is configured to generate the keys and values using the machine learning model.

Aspect 4. The apparatus of any of Aspects 1-3, wherein the first data comprises keys and values derived from messages exchanged between an external device and an autonomous agent, wherein the messages comprise text associated with a question, and wherein the sub-task represents a rephrased version of the question.

Aspect 5. The apparatus of any of Aspects 1-4, wherein, to process the first data and the sub-task output, the at least one processor is configured to process a main task context, wherein the main task context comprises information that affects how the machine learning model performs the first task.

Aspect 6. The apparatus of any of Aspects 1-5, wherein least one processor is configured to: output the task output to a database; obtain, from the database, a response to the task output; and provide the response to a user device.

Aspect 7. The apparatus of any of Aspects 1-6, wherein the machine learning model is a large language model.

Aspect 8. A method for generating content, comprising: obtaining first data for processing a first task using a machine learning model, wherein the first task comprises a sub-task; generating second data for processing the sub-task; processing the first data and the second data using the machine learning model to perform the sub-task and generate a sub-task output, wherein at least part of the first data, the second data, and the sub-task output are stored in a cache based on performance of the sub-task; removing at least part of the second data from the cache; and processing, using the machine learning model, the first data and the sub-task output from the cache to perform the first task and to generate a task output.

Aspect 9. The method of Aspect 8, wherein the second data comprises one or more of a context or an instruction for the sub-task, wherein the context comprises information that affects how the machine learning model performs the sub-task, and wherein the instruction comprises commands provided to the machine learning model for performing the sub-task.

Aspect 10. The method of any of Aspects 8-9, wherein the second data comprises keys and values, the method further comprising generating the keys and values using the machine learning model.

Aspect 11. The method of any of Aspects 8-10, wherein the first data comprises keys and values derived from messages exchanged between an external device and an autonomous agent, wherein the messages comprise text associated with a question, and wherein the sub-task represents a rephrased version of the question.

Aspect 12. The method of any of Aspects 8-11, wherein, processing the first data and the sub-task output further comprises processing a main task context, wherein the main task context comprises information that affects how the machine learning model performs the first task.

Aspect 13. The method of any of Aspects 8-12, further comprising: outputting the task output to a database; obtaining, from the database, a response to the task output; and providing the response to a user device.

Aspect 14. The method of any of Aspects 8-13, wherein the machine learning model is a large language model.

Aspect 15. Anon-transitory computer-readable medium is provided that has stored thereon instructions that, when executed by one or more processors, cause the one or more processors to: obtain first data for processing a first task using a machine learning model, wherein the first task comprises a sub-task; generate second data for processing the sub-task; process the first data and the second data using the machine learning model to perform the sub-task and generate a sub-task output, wherein at least part of the first data, the second data, and the sub-task output are stored in a cache based on performance of the sub-task; remove at least part of the second data from the cache; and process, using the machine learning model, the first data and the sub-task output from the cache to perform the first task and to generate a task output.

Aspect 16. The non-transitory computer-readable medium of Aspect 15, wherein the second data comprises one or more of a context or an instruction for the sub-task, wherein the context comprises information that affects how the machine learning model performs the sub-task, and wherein the instruction comprises commands provided to the machine learning model for performing the sub-task.

Aspect 17. The non-transitory computer-readable medium of any of Aspects 15-16, wherein the second data comprises keys and values, and wherein when executed by one or more processors, the instructions cause the one or more processors to generate the keys and values using the machine learning model.

Aspect 18. The non-transitory computer-readable medium of Aspects 15-17, wherein the first data comprises keys and values derived from messages exchanged between an external device and an autonomous agent, wherein the messages comprise text associated with a question, and wherein the sub-task represents a rephrased version of the question.

Aspect 19. The non-transitory computer-readable medium of Aspects 15-18, wherein processing the first data and the sub-task output comprises processing a main task context that comprises information that affects how the machine learning model performs the first task.

Aspect 20. The non-transitory computer-readable medium of Aspects 15-19, wherein when executed by one or more processors, the instructions cause the one or more processors to: output the task output to a database; obtain, from the database, a response to the task output; and provide the response to a user device.

Aspect 21: An apparatus including one or means for performing the operations of any of Aspects 1-20.

What is claimed is:

1. An apparatus for generating content, comprising:
at least one memory; and
at least one processor coupled to the at least one memory and configured to:
obtain first data for processing a first task using a machine learning model, wherein the first task comprises a sub-task;
generate second data for processing the sub-task;
process the first data and the second data using the machine learning model to perform the sub-task and generate a sub-task output, wherein at least part of the first data, the second data, and the sub-task output are stored in a cache based on performance of the sub-task;
remove at least part of the second data from the cache; and
process, using the machine learning model, the first data and the sub-task output from the cache to perform the first task and to generate a task output.

2. The apparatus of claim 1, wherein the second data comprises one or more of a context or an instruction for the sub-task, wherein the context comprises information that affects how the machine learning model performs the sub-task, and wherein the instruction comprises commands provided to the machine learning model for performing the sub-task.

3. The apparatus of claim 1, wherein the second data comprises keys and values, and wherein the at least one processor is configured to generate the keys and values using the machine learning model.

4. The apparatus of claim 1, wherein the first data comprises keys and values derived from messages exchanged between an external device and an autonomous agent, wherein the messages comprise text associated with a question, and wherein the sub-task represents a rephrased version of the question.

5. The apparatus of claim 1, wherein, to process the first data and the sub-task output, the at least one processor is configured to process a main task context, wherein the main task context comprises information that affects how the machine learning model performs the first task.

6. The apparatus of claim 1, wherein least one processor is configured to:
output the task output to a database;
obtain, from the database, a response to the task output; and
provide the response to a user device.

7. The apparatus of claim 1, wherein the machine learning model is a large language model.

8. A method for generating content, comprising:
obtaining first data for processing a first task using a machine learning model, wherein the first task comprises a sub-task;
generating second data for processing the sub-task;
processing the first data and the second data using the machine learning model to perform the sub-task and generate a sub-task output, wherein at least part of the first data, the second data, and the sub-task output are stored in a cache based on performance of the sub-task;
removing at least part of the second data from the cache; and
processing, using the machine learning model, the first data and the sub-task output from the cache to perform the first task and to generate a task output.

9. The method of claim 8, wherein the second data comprises one or more of a context or an instruction for the sub-task, wherein the context comprises information that affects how the machine learning model performs the sub-task, and wherein the instruction comprises commands provided to the machine learning model for performing the sub-task.

10. The method of claim 8, wherein the second data comprises keys and values, the method further comprising generating the keys and values using the machine learning model.

11. The method of claim 8, wherein the first data comprises keys and values derived from messages exchanged between an external device and an autonomous agent, wherein the messages comprise text associated with a question, and wherein the sub-task represents a rephrased version of the question.

12. The method of claim 8, wherein, processing the first data and the sub-task output further comprises processing a main task context, wherein the main task context comprises information that affects how the machine learning model performs the first task.

13. The method of claim 8, further comprising:
outputting the task output to a database;
obtaining, from the database, a response to the task output; and
providing the response to a user device.

14. The method of claim 8, wherein the machine learning model is a large language model.

15. A non-transitory computer-readable medium is provided that has stored thereon instructions that, when executed by one or more processors, cause the one or more processors to:
obtain first data for processing a first task using a machine learning model, wherein the first task comprises a sub-task;
generate second data for processing the sub-task;
process the first data and the second data using the machine learning model to perform the sub-task and generate a sub-task output, wherein at least part of the first data, the second data, and the sub-task output are stored in a cache based on performance of the sub-task;
remove at least part of the second data from the cache; and
process, using the machine learning model, the first data and the sub-task output from the cache to perform the first task and to generate a task output.

16. The non-transitory computer-readable medium of claim 15, wherein the second data comprises one or more of a context or an instruction for the sub-task, wherein the context comprises information that affects how the machine learning model performs the sub-task, and wherein the instruction comprises commands provided to the machine learning model for performing the sub-task.

17. The non-transitory computer-readable medium of claim 15, wherein the second data comprises keys and values, and wherein when executed by one or more processors, the instructions cause the one or more processors to generate the keys and values using the machine learning model.

18. The non-transitory computer-readable medium of claim 15, wherein the first data comprises keys and values derived from messages exchanged between an external device and an autonomous agent, wherein the messages comprise text associated with a question, and wherein the sub-task represents a rephrased version of the question.

19. The non-transitory computer-readable medium of claim 15, wherein processing the first data and the sub-task output comprises processing a main task context that comprises information that affects how the machine learning model performs the first task.

20. The non-transitory computer-readable medium of claim 15, wherein when executed by one or more processors, the instructions cause the one or more processors to:
output the task output to a database;
obtain, from the database, a response to the task output; and
provide the response to a user device.
